(19) United States
(12) Patent Application Publication
(10) Pub. No.: US 2004/0078266 A1
(43) Pub. Date: Apr. 22, 2004

(54) Advertisement method using download time of hand-held terminal

(76) Inventor: Hee-Seok Kim, Goyang-city (KR)

Correspondence Address: FISH & RICHARDSON PC, 225 FRANKLIN ST, BOSTON, MA, 02110, US

(21) Appl. No.: 10/416,610

(22) PCT Filed: Jul. 4, 2001
(86) PCT No.: PCT/KR01/01139

(30) Foreign Application Priority Data
Nov. 15, 2000 (KR) 2000/67601

(51) Int. Cl. G06F 17/60

(52) U.S. Cl. 705/14

(57) ABSTRACT

Disclosed is an advertisement method using a download time of a hand-held terminal. If the terminal connected to a server via a wireless Internet network selects a menu to be downloaded among contents menus that the server provides, the server segments a corresponding contents file of the selected menu based into packets having a predetermined size, the packets are downloaded according to a sequence of the segmentation, and a transmission rate of the corresponding contents file is displayed on an LCD window of the terminal in a shape of progress bar. The advertisement method comprising the steps of: inserting advertisement data between the packets of the selected contents file which is transmitted from the server and transmitting the download packet data and the advertisement data sequentially; and displaying the transmitted advertisement data on a predetermined portion of the LCD window.

### TECHNICAL FIELD

The present invention relates to an advertisement method using a terminal that has a wireless Internet access function, and more particularly, to an advertisement method for displaying an advertisement image on a display device of the hand-held terminal while on-line downloading contents programs, such as a game, provided by a website, thereby obtaining a high effectiveness of advertisement.

### BACKGROUND ART

Recently, a quality improvement and a diversity of wireless Internet services have revolutionized functions of a cellular phone, which is a representative personal hand-held terminal. Typically, main function of the cellular phone is to communicate with other people. However, as various functions including a wireless Internet access function are added to the cellular phone, users of the cellular phones can easily obtain desired information as well as a calculating execution using his/her own cellular phone regardless of place and time.

The greatest advantage of the hand-held terminal having the wireless Internet access function is to obtain the desired information or to download contents programs provided by a server. Specially, one of favorable functions in the hand-held terminal is an execution of game program, and the hand-held terminal having the wireless Internet access function can support a function of downloading and executing the desired game programs and the data at any time.

Most of the hand-held terminals spread on the market have several built-in game programs that are executable within the hand-held terminals. However, since there are limitations on the size of game programs and it is difficult to store many game programs in the hand-held terminal, various games cannot be provided to the user of the hand-held terminal. Accordingly, many users of the hand-held terminals pay attention to the wireless Internet services which are capable of connecting the hand-held terminal to a website through the wireless Internet network and on-line downloading and executing a lot of the game programs that the website provides.

FIG. 1 is a block diagram showing a typical web service system using a hand-held terminal that has a wireless Internet browsing function. Referring to FIG. 1, a web server 11, a download server 12 and a scoring server 13 are connected to a wireless Internet network in order to provide a download service of contents programs such as a game through the wireless Internet network, thereby making it possible to respond to the download request of the contents programs from a hand-held terminal 10 that is connected via the wireless Internet network.

In such a system, the hand-held terminal must have a browsing function in order for the user of the hand-held terminal to use the download service. If the hand-held terminal is connected to the web server 11 storing a list of the contents such as a game and a desired menu of the contents is selected, the web server 11 transmits the download server information of contents providers to the hand-held terminal 10.

If the download server information is transmitted to the hand-held terminal 10, the hand-held terminal 10 transmits its own information to the download server 12. Then, the hand-held terminal 10 downloads the contents programs such as a selected game and an application program, and executes the downloaded contents programs.

FIG. 2 is a flowchart showing sequential steps of downloading mobile contents that the server provides to the hand-held terminal. Referring to FIG. 2, if the hand-held terminal selects a game provided by the web server, the web server designates the download server and the scoring server.

Then, the hand-held terminal is connected to the designated download server to send its own information, and downloads the selected contents. If the download is completed, the hand-held terminal transmits an acknowledge (ACK) signal to the download server, thereby completing a series of download process.

FIG. 3 is a flowchart showing a sequential procedure of downloading the contents that the server provides. In FIG. 3, a hand-held terminal includes a mobile application plug-in solution (MAP) management unit (MMU) and a mobile part. Also, FIG. 3 shows the signals and information that the MMU and the mobile part transmit and retrieve between the web server and the download server.

First, the mobile part of the hand-held terminal drives a browser to connect the web server, and then, a desired menu is selected among the contents menus, such as a game, provided the web server.

In case where the hand-held terminal selects a menu to be downloaded, the web server transmits the corresponding contents information to the hand-held terminal. If the hand-held terminal stops the browser, the download of the corresponding contents is cancelled. If not, a web tag analysis and a storage/memory management are executed to initialize the MMU, and then, a transmission control protocol (TCP) socket open is requested.

If the download server establishes the TCP socket, the mobile part commands a download start operation to the MMU. Then, if the MMU requests a TCP transmission, the mobile part performs a socket write operation and a socket read operation with respect to the download server and requests a TCP read operation to the MMU. If the initialization of the MMU and the TCP read operation fail, this status is determined as a function error and the TCP socket is closed.

If the MMU sets up a continuous download according to the TCP read request, the MMU saves a non-volatile memory header and requests the TCP transmission to the mobile. Accordingly, the mobile part performs a socket write operation and a socket read operation with respect to the download server and requests again the TCP read operation.

The contents files downloaded in the MMU are segmented into packets having a predetermined size. Then, based on the packets, the segmented contents files are sequentially transmitted and the transmission is identified. At this time, a transmission ACK information is read at every moment, and a data transmission rate is displayed on an LCD in a shape of a progress bar. Every when a transmission of each packet is completed, the progress bar is filled up with segments one by one. Also, it can be displayed based on the percentage of the transmission rate.

If the MMU completes the download, the MMU sends a write completion signal and a TCP write signal to the mobile part to allow the download server to close the TCP socket.

If the contents program size is about 60 Kbytes, it takes about 2 minutes to download the mobile contents under the condition of the present wireless Internet access. During this download time, other functions are not permitted to be available. Only the progress bar and the percentage of the transmission rate are displayed on the LCD window of the hand-held terminal. One example is shown in FIG. 4.

Accordingly, the user of the hand-held terminal may fix his/her eyes on the LCD window while the contents such as a web game are downloaded. If else, a wireless Internet access time may be increased so that unnecessary wireless Internet access charges are imposed on the users.

### DISCLOSURE OF THE INVENTION

Therefore, an object of the invention is to resolve the above problem and to obtain a high effectiveness of advertisement by displaying an advertisement on a display device of a hand-held terminal while the hand-held terminal downloads programs such as a game.

To accomplish the above objects and advantages, there is provided an advertisement method using a download time of a hand-held terminal. If the terminal connected to a server via a wireless Internet network selects a menu to be downloaded among contents menus that the server provides, the server segments a corresponding contents file of the selected menu based into packets having a predetermined size, the packets are downloaded according to a sequence of the segmentation, and a transmission rate of the corresponding contents file is displayed on an LCD window of the terminal in a shape of progress bar. The advertisement method comprising the steps of: inserting advertisement data between the packets of the selected contents file which is transmitted from the server and transmitting the download packet data and the advertisement data sequentially; and displaying the transmitted advertisement data on a predetermined portion of the LCD window of the terminal in the shape of an image file while downloading the contents files.

### BRIEF DESCRIPTION OF THE DRAWINGS

The above object, other features and advantages of the present invention will become more apparent by describing the preferred embodiment thereof with reference to the accompanying drawings, in which:

FIG. 1 is a block diagram showing a typical web service system using a hand-held terminal that has a wireless Internet browsing function;

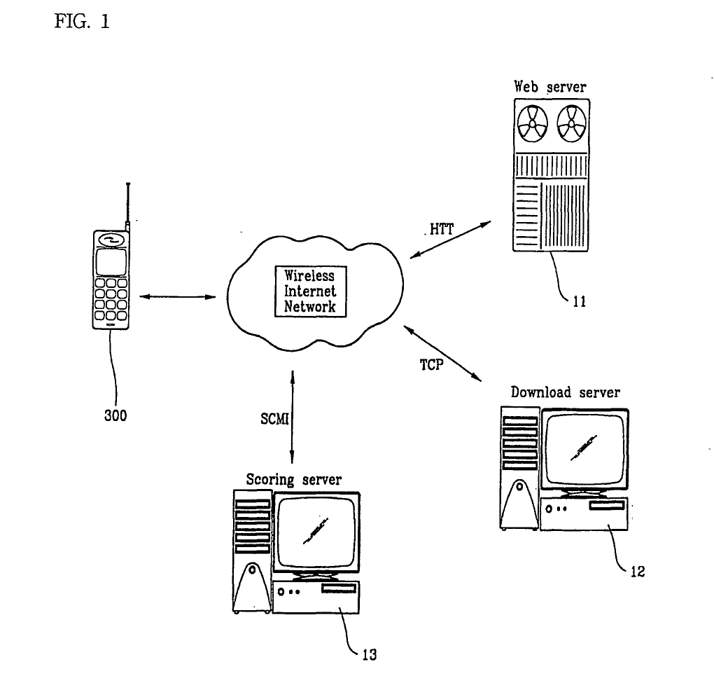

FIG. 2 is a flowchart showing sequential steps of downloading mobile contents that a server provides to the hand-held terminal;

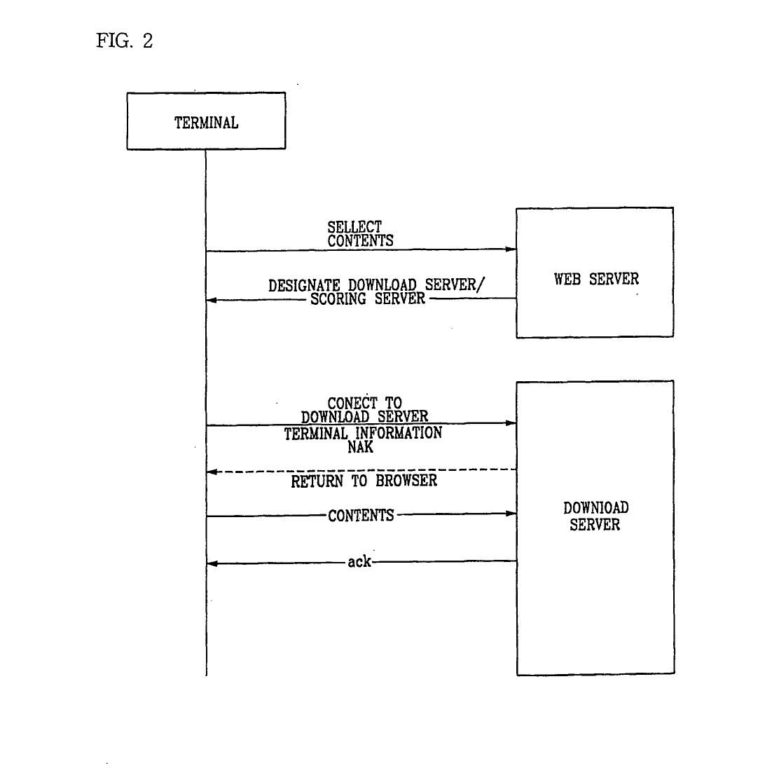

FIG. 3 is a flowchart showing a sequential procedure of downloading the contents that the server provides;

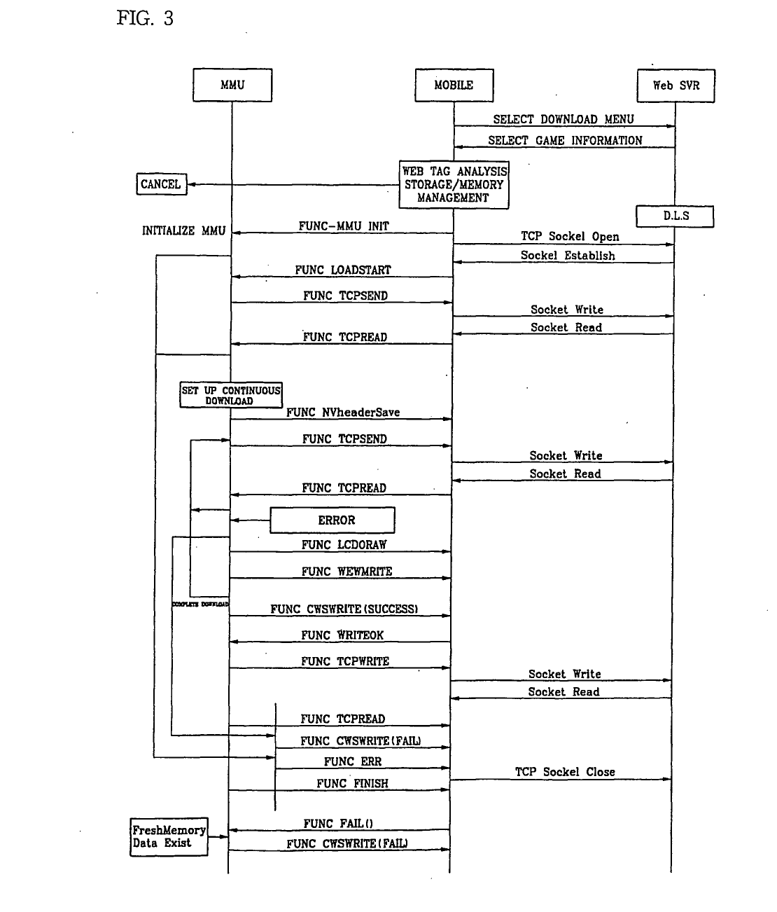

FIG. 4 is an example showing a scene displayed on a display device of the hand-held terminal when downloading contents data provided by the server;

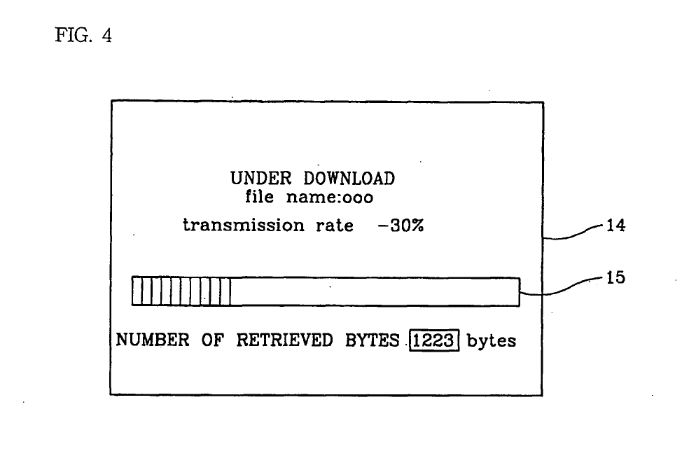

FIG. 5 is a flowchart showing sequential steps of displaying a real-time advertisement on a display device of a hand-held terminal while downloading contents in accordance with the present invention; and

FIG. 6 is an example showing a progress bar and an advertisement image displayed on an LCD window of the hand-held terminal in accordance with the present invention.

### BEST MODE FOR CARRYING OUT THE INVENTION

Now, preferred embodiments of the present invention will be described in detail with reference to the annexed drawings.

To begin with, a hand-held terminal which supports a wireless Internet access function is connected to a web server. Then, if a specific menu is selected among contents menus that the web server provides, the web server transmits corresponding contents program information, such as a download server information, a program size, an execution condition and the like, to the hand-held terminal. The hand-held terminal checks whether a download and an execution of the corresponding contents are available or not. In case where it is determined to be within an allowable limit, the hand-held terminal requests an opening of a TCP socket to a download server.

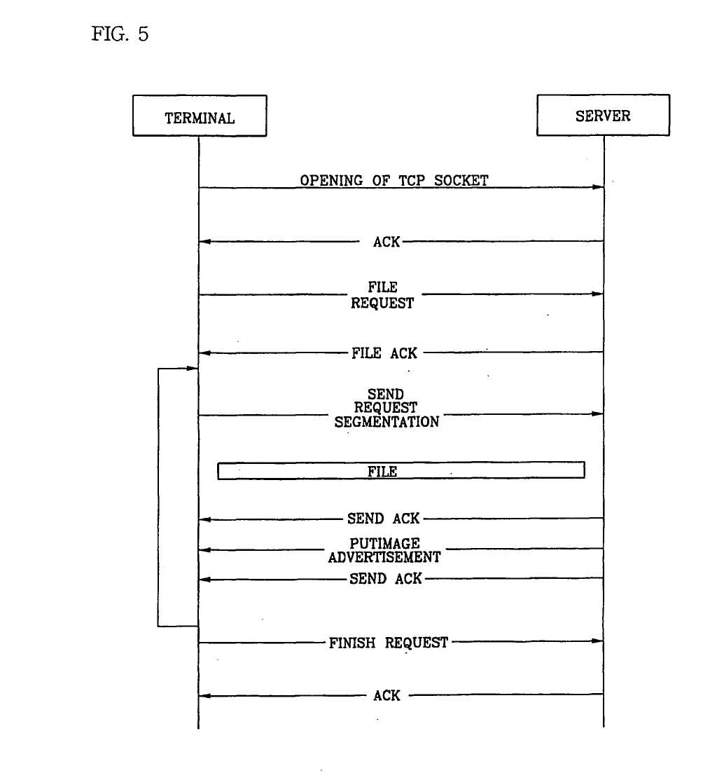

FIG. 5 is a flowchart showing sequential steps of displaying real-time advertisements on a display device of a hand-held terminal while downloading the contents.

Referring to FIG. 5, if the hand-held terminal requests an opening of a TCP socket, a download server sends a socket opening acknowledge (ACK) signal to the hand-held terminal. If the hand-held terminal identifies the TCP socket opening ACK signal, the terminal transmits a file request signal and waits for a file request ACK signal.

If the hand-held terminal retrieves the file request ACK signal transmitted from the download server, the hand-held terminal transmits a send request of the contents programs (or data), which are to be downloaded, to the download server. If the download server retrieves the send request, the download server transmits a file segmented based on packets which have a predetermined size.

Segmentation of the file to be downloaded is composed of the packets, each of which has 1000 bytes in size. Therefore, if an average size of the contents provided by the download server is about 640 Kbytes, the contents such as a game is composed of about 50 to 60 segment packets.

A packet transmission is requested and identified based on sequential segmentation packets. When one packet data transmission is completed, the download server transmits a prepared advertisement data in a form of an image file. These advertisement image data files including an output coordinate value of an LCD window are temporarily managed by the MMU. As a result, the advertisement image data files are displayed as an advertisement on a predetermined portion of the LCD window.

That is, when the contents data files to be downloaded are transmitted based on the packets, the advertisement (image) files are inserted between each packet and transmitted alternately and sequentially. Therefore, when the contents program for the hand-held terminal is downloaded, a prepared advertisement text of an image form is displayed on the predetermined portion of the LCD window.

In case where the packet file for advertisements is made based on a data size for forming one image, if the segmentation of the contents program to be downloaded is composed of 50 packets, 50 advertisement scenes can be created and displayed while the contents program is downloaded. In order for an effective advertisement, however, it is possible to allow only one or several advertisements to be displayed on the LCD window while downloading one of the contents.

In accordance with the present invention, when the contents for hand-held terminal are downloaded, the advertisement display causes the download time to be increased wholly. This may give a disadvantage to the user of the hand-held terminal when the contents such as a web game are downloaded. However, when the contents programs are downloaded, the watching on the advertisements leads to a discount of Internet access charges as well as a development and provision of high-quality various contents, thereby giving an advantage to the user of the contents.

While downloading one contents file, if the number or the kind of advertisements displayed on the LCD window is one or several, the advertisements and the downloads can be simultaneously executed without increasing the total download time.

That is, the advertisement files inserted between the packets of contents to be downloaded need not be repeatedly sent every when the transmission completion of each packet data is checked. The MMU stores temporarily an advertisement file that is sent at first and the temporarily stored advertisement file is refreshed every when the download server requests a repeated send, thereby reducing the transmission time of the contents for use in the hand-held terminal remarkably.

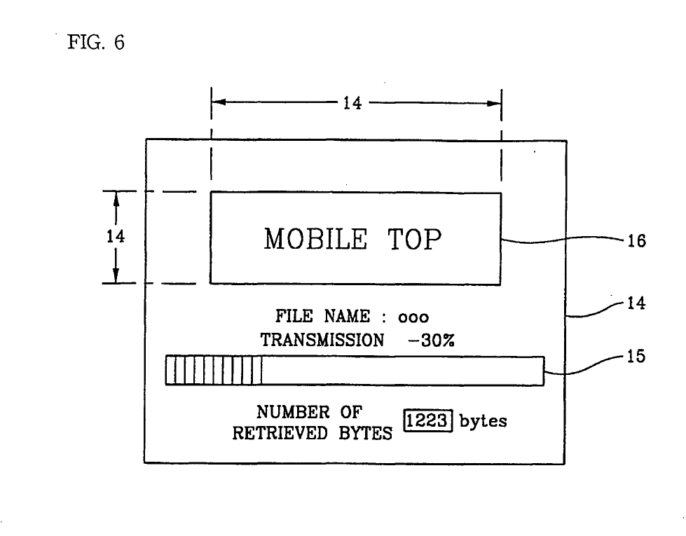

FIG. 6 is an example showing a progress bar and an advertisement image displayed on an LCD window of the hand-held terminal in accordance with the present invention.

Referring to FIG. 6, the download progress status of the contents programs and the (image) advertisement are displayed on a predetermined portion of the LCD window while the contents programs is downloaded from the download server to the hand-held terminal.

For example, if a size of an advertisement displaying area 16 is set to 96 pixels and 28 pixels in a length L and a width W, respectively, and if the LCD operates in a 4 gray mode, the number of image bytes becomes 672 bytes. When the advertisement is displayed on the LCD window under the condition of 96×28 pixels, if one packet of the downloaded program is set to 1000 bytes, the total download time is increased as much as about ⅔ times.

Accordingly, when the web contents programs are downloaded to the hand-held terminal, the size of the advertisement displayed on the LCD window affects the total download time directly. Therefore, the server can adjust properly the size of the advertisement according to a value of corresponding contents.

In addition to the display of the advertisement on the LCD, the progress bar 15 is displayed on a remaining space of the LCD. If there is another remaining space, a percentage of the transmission rate can be displayed thereon.

While the advertisement method of the present invention have been described in detail with reference to the preferred embodiments, those skilled in the art will appreciate that various modifications and substitutions can be made thereto without departing from the spirit and scope of the present invention as set forth in the appended claims.

### Industrial Applicability

As described above, the present invention has the following advantages:

A high effectiveness of advertisement is obtained by displaying an advertisement on a display device of a hand-held terminal while the hand-held terminal accessed to a server via a wireless Internet network downloads the contents programs provided by the server.

1. An advertisement method using a download time of a hand-held terminal, wherein if the terminal connected to a server via a wireless Internet network selects a menu to be downloaded among contents menus that the server provides, the server segments a corresponding contents file of the selected menu based into packets having a predetermined size, the packets are downloaded according to a sequence of the segmentation, and a transmission rate of the corresponding contents file is displayed on an LCD window of the terminal in a shape of progress bar, the advertisement method comprising the steps of:
inserting advertisement data between the packets of the selected contents file which is transmitted from the server and transmitting the download packet data and the advertisement data sequentially; and
displaying the transmitted advertisement data on a predetermined portion of the LCD window of the terminal in the shape of an image file while downloading the contents files.

2. The advertisement method of claim 1, wherein in case where the advertisement data inserted between the packets of the selected contents file are equal to each other, an MMU stores temporarily an advertisement data file which is sent at first, and the temporarily stored advertisement data file is refreshed when a repeated send is requested, thereby reducing a download time of the contents files.
